(19) United States
(12) Patent Application Publication
(10) Pub. No.: US 2024/0010361 A1
(43) Pub. Date: Jan. 11, 2024

(54) SHARED THERMAL CAPACITOR IN A MULTI-THRUSTER SYSTEM

(71) Applicant: MOMENTUS SPACE LLC, San Jose, CA (US)

(72) Inventor: Mikhail Kokorich, Los Altos Hills, CA (US)

(21) Appl. No.: 18/024,698

(22) PCT Filed: Sep. 2, 2021
(86) PCT No.: PCT/US21/48889

§ 371 Date: Mar. 3, 2023

Related U.S. Application Data
(60) Provisional application No. 63/074,453, filed on Sep. 3, 2020.

(51) Int. Cl. B64G 1/40

(52) U.S. Cl. CPC B64G 1/4021

(57) ABSTRACT

A spacecraft propulsion system comprises an attitude adjustment thruster system with multiple thrusters (488a-d) receiving heated propellant via a shared thermal capacitance block (275). The thermal capacitance block (275) receives energy from a solar concentrator (320) and stores the heat.

### FIELD OF THE DISCLOSURE

The disclosure generally relates to operating a spacecraft and more specifically to operating an attitude adjustment thruster system with a common heater implemented as a thermal capacitance block.

### BACKGROUND

With increased commercial and government activity in the near space, a variety of spacecraft and missions are under development. For example, some spacecraft may be dedicated to delivering payloads (e.g., satellites) from one orbit to another. In such orbital transfer missions, thruster systems, including attitude adjustment thrusters, may be designed for reliability to consistently achieve mission objectives.

Current attitude adjustment thruster systems may include multiple thrusters (e.g., electro-jets) that receive propellant from a tank and have electrical components to add energy to the propellant. These systems may have a number of possible failure modes.

Furthermore, managing and distributing energy in the spacecraft (including to the attitude adjustment thrusters) remains a challenge. There are existing inefficiencies in collecting solar energy and storing it. Additionally, there are heat sources in various spacecraft subsystems that need to be removed from the spacecraft and radiated into space.

### SUMMARY

This disclosure generally relates to improving reliability of a maneuvering or attitude adjustment thruster system . . . .

In one embodiment, a device for heating a propellant in a spacecraft includes a thermal capacitor block of a certain volume, the thermal capacitor block configured to operate in a low-pressure environment and including at least one material to store thermal energy. The device further includes one or more integrated fluidic channels traversing the thermal capacitor block and configured to carry the propellant so as to transfer heat from the at least one material to the propellant, wherein the one or more fluidic channels occupy a minority of the volume, and the material occupies a majority of the volume.

In another embodiment, a spacecraft includes a propellant tank, at least one thruster, and a heating device configured to receive propellant from the propellant tank and supply the propellant to the thruster. The heating device includes a thermal capacitor block of a certain volume, the thermal capacitor block configured to operate in a low-pressure environment and includes at least one material to store thermal energy. The heating device further includes one or more fluidic channels traversing the thermal capacitor block and configured to carry the propellant so as to transfer heat from the thermal capacitor block to the propellant, wherein the one or more fluidic channels occupy a minority of the volume, and the material occupies a majority of the volume.

In yet another embodiment, a spacecraft maneuvering system includes a propellant tank and a shared thermal capacitor including a material configured to store thermal energy, the shared thermal capacitor configured to (i) receive, via a plurality of ingress ports, a propellant for a plurality of respective fluidic channels, (ii) transfer the stored thermal energy to the propellant in the plurality of fluidic channels, and (iii) output the propellant from the plurality of fluidic channels via a plurality of a respective egress ports. The system further includes a plurality of valves configured to restrict an amount of propellant directed to the respective ingress ports; and a controller configured to control the plurality of the valves to change flow rates through the plurality of the fluidic channels in response to signals indicative of intended spacecraft maneuvers.

In yet another embodiment, a method of maneuvering a spacecraft includes directing a propellant from a propellant tank to a plurality of fluidic channels in thermal communication with a shared thermal capacitor, via a plurality of respective valves, including controlling, by a controller, flow rates through the valves in accordance with intended spacecraft maneuvers. The method further includes transferring thermal energy stored in a material of the thermal capacitor to the propellant in the plurality of fluidic channels. and directing the propellant from the plurality of fluidic channels to respective ones of a plurality of thrusters.

In yet another embodiment, a solar concentrator device configured to operate in a spacecraft and collect solar energy includes: a reflecting side configured to focus solar radiation on a thermal target disposed at the spacecraft, and a radiating side configured to receive thermal energy from the spacecraft and to radiate the received thermal energy. The device further includes a heat transfer component to transfer thermal energy from the spacecraft to the radiating side.

In yet another embodiment, a method of managing thermal energy in a spacecraft includes: focusing, using a reflective side of a solar concentrator, solar radiation on a thermal target; transferring, using a heat transfer component, thermal energy from the spacecraft to the radiating side of the solar concentrator; and radiating, using the radiating side of the solar concentrator, the transferred thermal energy.

In yet another embodiment, a thermal system for use in a spacecraft includes a thermal target including an absorbing surface configured to absorb solar radiation, and a solar concentrator configured to direct solar radiation toward the thermal target, via an optical path. The thermal system is configured to reflect at least a portion of thermal radiation emitted by the thermal target, in the optical path, back to the thermal target.

In yet another embodiment, a method of managing thermal energy in a spacecraft includes directing, using a solar concentrator, solar radiation on a thermal target via an optical path, and causing at least a portion of thermal radiation emitted by the thermal target to be reflected back to the thermal target, in the optical path.

### BRIEF DESCRIPTION OF THE DRAWINGS

FIG. 1 is a block diagram of a spacecraft configured for transferring a payload between orbits.

FIGS. 2A and 2B illustrate the distinction between a known attitude control thruster system and an example disclosed attitude control thruster.

FIG. 3 schematically illustrates an example implementation of an attitude control thruster system with a shared thermal capacitor block.

FIG. 4 is a perspective illustration of a spacecraft in which an example attitude control thruster system may operate.

FIGS. 5A, B illustrate example implementations of the attitude adjustment thruster system with emphasis on controlling the propellant system.

FIGS. 6A, B illustrate example thermal capacitor blocks with integrated fluidic channels.

FIG. 7 illustrates configurations of thermal systems for managing radiant energy transfer between a thermal block and the environment surrounding the thermal block.

FIG. 8 illustrates a solar concentrator with a reflecting side to collect solar energy and a radiating side to dissipate heat operating in a spacecraft.

### DETAILED DESCRIPTION

Spacecraft may be configured for transferring a payload from a lower energy orbit to a higher energy orbit according to a set of mission parameters. The mission parameters may include, for example, a time to complete the transfer and an amount of propellant and/or fuel available for the mission. Generally, spacecraft may collect solar energy and use the energy as well as the stored propellant to generate thrust using one or more thrusters. The spacecraft may use distinct sets of thrusters for changing orbit energy and maneuvering to change spacecraft orientation with respect to an orbit. In some implementations, a spacecraft maneuvering system, or, equivalently, an attitude adjustment thruster system, may be used for docking with other spacecraft, payloads, or fuel depots in space. Different thruster types and/or operating modes may trade off the total amount of thrust with the efficiency of thrust with respect to fuel or propellant consumption, defined as a specific impulse. Different thruster types or thruster systems may have different levels of complexity and reliability. Generally, optimizing and/or simplifying thruster systems may improve spacecraft efficiency and/or reliability.

A disclosed spacecraft includes a system of multiple attitude adjustment, otherwise referred to as maneuvering, thrusters sharing energy system components to kinetically energize supplied propellant. In some implementations, the attitude adjustment (i.e., maneuvering) system may be a passive structure expelling the energized propellant through nozzles. Such thruster configuration may increase thruster system reliability by reducing possible failure modes, for example, by obviating individual heating elements in the maneuvering thrusters. Furthermore, the disclosed enabling energy system components increase energy efficiency of the spacecraft by efficiently converting sunlight into propellant energy. Still furthermore, the disclosed maneuvering thruster system is scalable because a robust common heater may replace individual in-thruster electrical heating elements (e.g., in electro-jets) that can have power limitations.

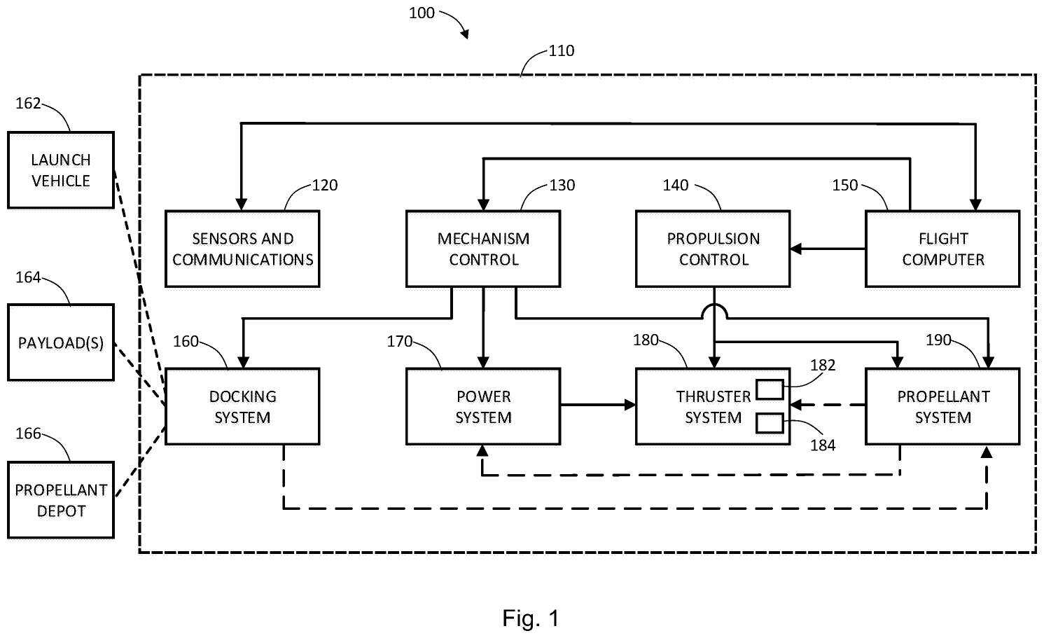

FIG. 1 is a block diagram of a spacecraft 100 configured for transferring a payload between orbits. The spacecraft 100 may include the disclosed attitude adjustment thruster system (referred to as a subsystem in the context of a thruster system that includes other thrusters) and supporting energy system components. The spacecraft 100 includes a number of systems, subsystems, units, or components disposed in or at a housing 110. The subsystems of the spacecraft 100 may include sensors and communications components 120, mechanism control 130, propulsion control 140, a flight computer 150, a docking system 160 (for attaching to a launch vehicle 162, one or more payloads 164, a propellant depot 166, etc.), a power system 170, a thruster system 180 that includes a primary propulsion (main) thruster subsystem 182 and an attitude adjustment thruster subsystem 184, and a propellant system 190. Furthermore, any combination of subsystems, units, or components of the spacecraft 100 involved in determining, generating, and/or supporting spacecraft propulsion (e.g., the mechanism control 130, the propulsion control 140, the flight computer 150, the power system 170, the thruster system 180, and the propellant system 190) may be collectively referred to as a propulsion system of the spacecraft 100.

The sensors and communications components 120 may include a number of sensors and/or sensor systems for navigation (e.g., imaging sensors, magnetometers, inertial motion units (IMUs), Global Positioning System (GPS) receivers, etc.), temperature, pressure, strain, radiation, and other environmental sensors, as well as radio and/or optical communication devices to communicate, for example, with a ground station, and/or other spacecraft. The sensors and communications components 120 may be communicatively connected with the flight computer 150, for example, to provide the flight computer 150 with signals indicative of information about spacecraft position and/or commands received from a ground station.

The flight computer 150 may include one or more processors, a memory unit, computer readable media, to process signals received from the sensors and communications components 120 and determine appropriate actions according to instructions loaded into the memory unit (e.g., from the computer readable media). Generally, the flight computer 150 may be implemented using any suitable combination of processing hardware, that may include, for example, applications specific integrated circuits (ASKS) or field programmable gate arrays (FPGAs), and/or software components. The flight computer 150 may generate control messages based on the determined actions and communicate the control messages to the mechanism control 130 and/or the propulsion control 140. For example, upon receiving signals indicative of a position of the spacecraft 100, the flight computer 150 may generate a control message to activate one of the thruster subsystems 182, 184 in the thruster system 180 and send the message to the propulsion control 140. The flight computer 150 may also generate messages to activate and direct sensors and communications components 120.

The docking system 160 may include a number of structures and mechanisms to attach the spacecraft 100 to a launch vehicle 162, one or more payloads 164, and/or a propellant refueling depot 166. The docking system 160 may be fluidicly connected to the propellant system 190 to enable refilling the propellant from the propellant depot 166. Additionally or alternatively, in some implementations at least a portion of the propellant may be disposed on the launch vehicle 162 and outside of the spacecraft 100 during launch. The fluidic connection between the docking system 160 and the propellant system 190 may enable transferring the propellant from the launch vehicle 162 to the spacecraft 100 upon delivering and prior to deploying the spacecraft 100 in orbit.

The power system 170 may include components for collecting solar energy, generating electricity and/or heat, storing electricity and/or heat, and delivering electricity and/or heat to the thruster system 180. To collect solar energy, the power system 170 may include solar panels with photovoltaic cells, solar collectors or concentrators with mirrors and/or lenses, or a suitable combination of devices. In the case of using photovoltaic devices, the power system 170 may convert the solar energy into electricity and store it in energy storage devices (e.g., lithium ion batteries, fuel cells, etc.) for later delivery to the thruster system 180 and other spacecraft components. In some implementations, the power system 180 may deliver at least a portion of the generated electricity directly (i.e., bypassing storage) to the thruster system 180 and/or to other spacecraft components. When using a solar concentrator, the power system 170 may direct the concentrated (having increased irradiance) solar radiation to photovoltaic solar cells to convert to electricity. In other implementations, the power system 170 may direct the concentrated solar energy to a solar thermal receiver or simply, a thermal receiver, that may absorb the solar radiation to generate heat. The power system 170 may use the generated heat to power a thruster directly, as discussed in more detail below, and/or to generate electricity using, for example, a turbine or another suitable technique (e.g., a Stirling engine). The power system 170 then may use the electricity directly for generating thrust or storing electrical energy.

The thruster system 180 may include a number of thrusters and other components configured to generate propulsion or thrust for the spacecraft 100. Thrusters may generally include main thrusters in the primary propulsion subsystem 182 that are configured to substantially change speed of the spacecraft 100, or as attitude control thrusters in the attitude control thruster subsystem 184 that are configured to change direction or orientation of the spacecraft 100 without substantial changes in speed.

One or more thrusters in the primary propulsion subsystem 182 may be a microwave-electro-thermal (MET) thrusters. In a MET thruster cavity, an injected amount of propellant may absorb energy from a microwave source (that may include one or more oscillators) included in the thruster system 180 and, upon partial ionization, further heat up, expand, and exit the MET thruster cavity through a nozzle, generating thrust.

Another one or more thrusters in the primary propulsion subsystem 182 may be solar thermal thrusters. In one implementation, propellant in a thruster cavity acts as the solar thermal receiver and, upon absorbing concentrated solar energy, heats up, expands, and exits the nozzle generating thrust. In other implementations, the propellant may absorb heat before entering the cavity either as a part of the thermal target or in a heat exchange with the thermal target or another suitable thermal mass thermally connected to the thermal target. In some implementations, while the propellant may absorb heat before entering the thruster cavity, the primary propulsion thruster subsystem 182 may add more heat to the propellant within the cavity using an electrical heater or directing a portion of solar radiation energy to the cavity.

Thrusters in the attitude adjustment subsystem 184 may use propellant that absorbs heat before entering the cavities of the attitude adjustment thrusters in a heat exchange with the thermal target or another suitable thermal mass thermally connected to the thermal target. In some implementations, while the propellant may absorb heat before entering thruster cavities, the thrusters of the attitude adjustment thruster subsystem 184 may add more heat to the propellant within the cavity using corresponding electrical heaters.

The propellant system 190 may store the propellant for use in the thruster system 180. The propellant may include water, hydrogen peroxide, hydrazine, ammonia or another suitable substance. The propellant may be stored on the spacecraft in solid, liquid, and/or gas phase. To that end, the propellant system 190 may include one or more tanks, including, in some implementations, deployable tanks. To move the propellant within the spacecraft 100, and to deliver the propellant to one of the thrusters, the propellant system 190 may include one or more pumps, valves, and pipes. The propellant may also store heat and/or facilitate generating electricity from heat, and the propellant system 190 may be configured, accordingly, to supply propellant to the power system 170.

The mechanism control 130 may activate and control mechanisms in the docking system 160 (e.g., for attaching and detaching a payload or connecting with an external propellant source), the power system 170 (e.g., for deploying and aligning solar panels or solar concentrators), and/or the propellant system 190 (e.g., for changing configuration of one or more deployable propellant tanks). Furthermore, the mechanism control 130 may coordinate interaction between subsystems, for example, by deploying a tank in the propellant system 190 to receive propellant from an external propellant source connected to the docking system 160.

The propulsion control 140 may coordinate the interaction between the thruster system 180 and the propellant system 190, for example, by activating and controlling electrical components (e.g., a microwave source) of the thruster system 140 and the flow of propellant supplied to thrusters by the propellant system 190. Additionally or alternatively, the propulsion control 140 may direct the propellant through elements of the power system 170. For example, the propellant system 190 may direct the propellant to absorb the heat (e.g., at a heat exchanger) accumulated within the power system 170. Vaporized propellant may then drive a power plant (e.g., a turbine, a Stirling engine, etc.) of the power system 170 to generate electricity. Additionally or alternatively, the propellant system 190 may direct some of the propellant to charge a fuel cell within the power system 190. Still further, the attitude adjustment thruster subsystem 184 may directly use the heated propellant to generate thrust.

The subsystems of the spacecraft may be merged or subdivided in different implementations. For example, a single control unit may control mechanisms and propulsion. Alternatively, dedicated controllers may be used for different mechanisms (e.g., a pivot system for a solar concentrator), thrusters (e.g., a MET thruster), valves, etc. In the following discussion, a controller may refer to any portion or combination of the mechanism control 130 and/or propulsion control 140.

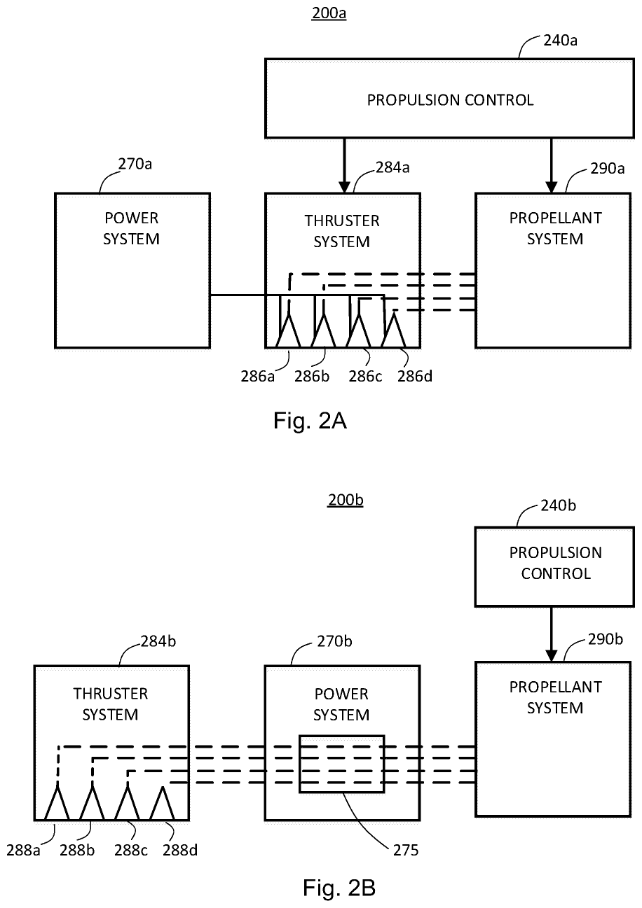

FIGS. 2A and 2B illustrate the distinction between a known attitude control thruster system 200a and an example disclosed attitude control thruster system 200b, each exemplifying the attitude control subsystem 184. The systems 200a,b include propulsion controls 240a,b, power systems 270a,b, thruster systems 284a,b, and propellant systems 290a,b, exemplifying, respectively, propulsion control 140, power system 170, attitude control thruster subsystem 184, and propellant system 190. The power system 270b may include a thermal block 275, described below. The thruster system 284a includes four thrusters 286a-d. The thruster systems 284b, analogously, includes four thrusters 288a-d. Generally, the systems 200a,b may include any suitable number (2, 2, 4, 5, 6, 7, 8, 9, 10, 12, etc.) of thrusters. The thrusters 288a-d may be different from the thrusters 286a-d. For example, the thrusters 288a-d may operate without the need for electrical components, enabling a more robust and scalable maneuvering system.

The thruster system 200a, is configured to use thrusters 286a-d that each receive a supply of propellant from the propellant system 290a and a supply of power from the power system 270a. Each of the thrusters 286a-d is configured to individually convert the supplied power into energy of the supplied propellant. Such thrusters may be, for example, electro-jet or micro-plasma thrusters.

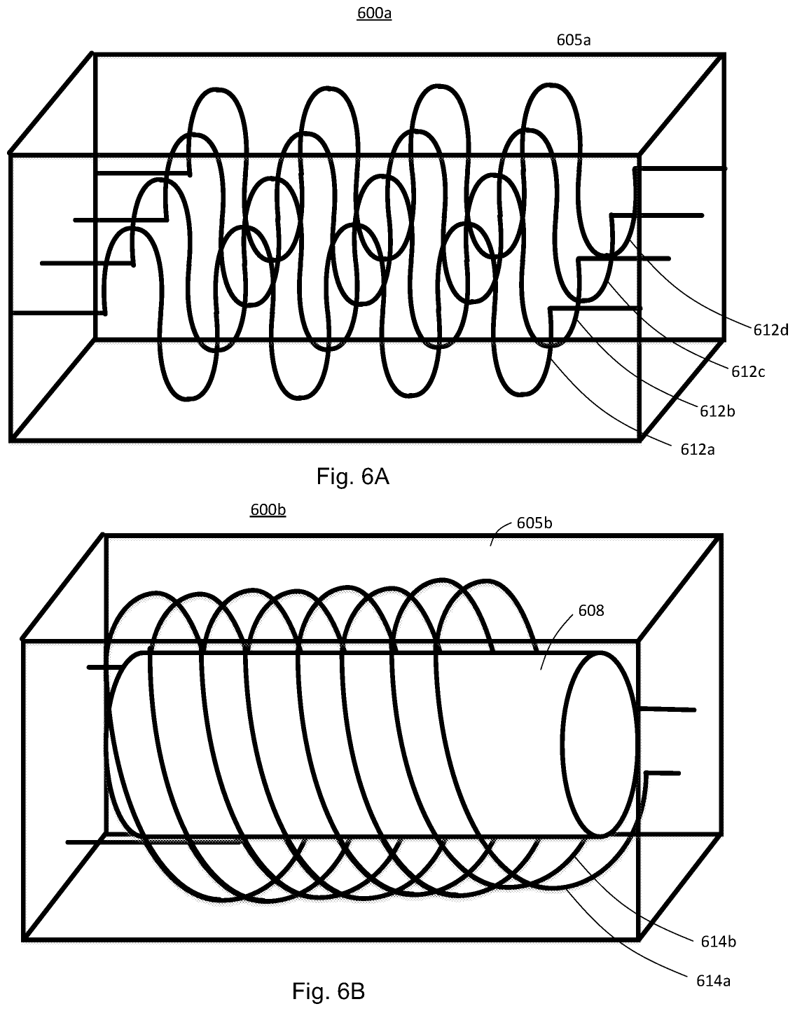

In contrast, the thruster system 200b is configured to use thrusters 288 a-d that each receive high-temperature (e.g., 100, 150, 250, 400, 600, 900, 1200, etc. ° C.) propellant pre-heated by the power system 270b. To that end, the power system 170b may include the thermal capacitor block 275, that may be referred to as a thermal capacitance block, thermal block or a thermal capacitor. The thermal block 275 may act as a thermal target receiving energy from a solar collector, as described below. In some implementations, the thermal block 275 may include an electrical heater to raise the block temperature through Joule heating. The heater may be embedded in a ceramic material to electrically isolate the heater from a potentially conductive material of the block 275. The thermal block 275 may be a device that combines functionalities of a heat storage device and a thermal exchanger by combining thermal mass having substantial heat capacity with a number of integrated fluidic channels. The number of the integrated fluidic channels may correspond to the number of thrusters (e.g., four fluidic channels for the thrusters 288a-d). The thrusters 288a-d may run through the thermal capacitor block 275 so as to heat the working fluid, which, in the case of the system 200b, is the propellant for the thrusters 288a-d. The thermal capacitor block is described in more detail below, with reference to FIGS. 6A, B.

It should be noted that a thruster system with a thermal capacitance block (e.g., block 275) may be configured to operate with a single thruster, using a dedicated fluidic channel. Furthermore, the thermal capacitor block may include a secondary fluidic channel, coupled to a non-thruster component. The secondary channel may carry a working fluid used, for example, for power production (e.g., with a turbine).

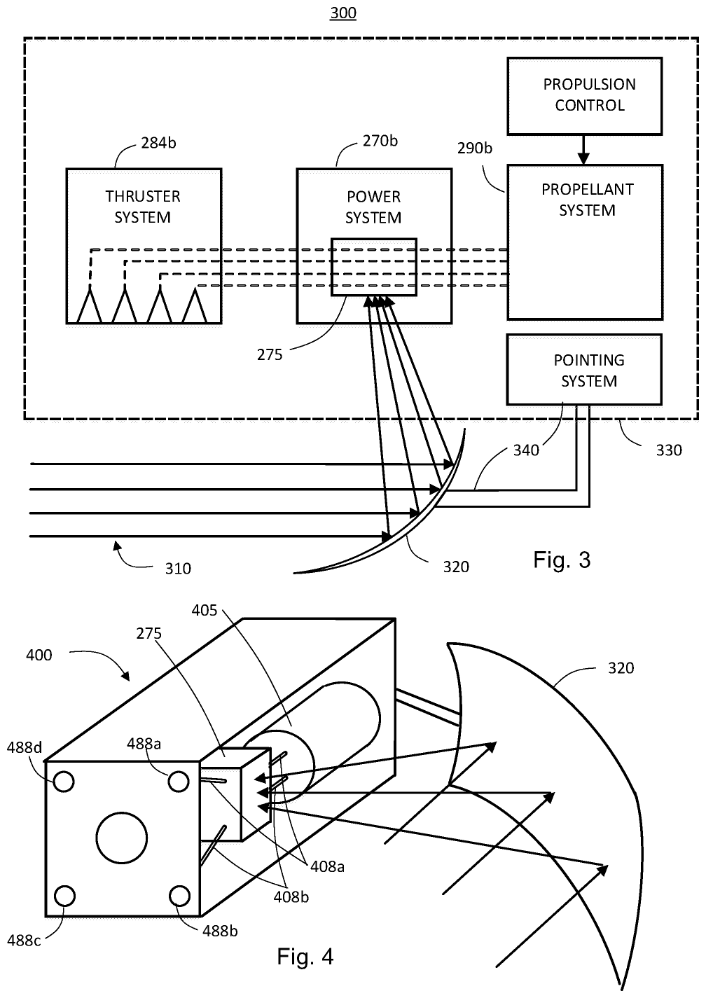

FIG. 3 schematically illustrates an example implementation 300 of the thruster system 200b with the thermal block 275 receiving solar energy (designated by rays 310) collected and directed by a solar collector 320 disposed outside of a satellite housing 330 and controlled by a pointing system 340. The solar collector 320 may be referred to as the solar concentrator 320. The pointing system 340 is mechanically attached to the solar collector 320 and may include a portion of the mechanism control 130 along with a mechanism (e.g., actuators, beams, gears, tethers, etc.) for deploying and/or moving the solar collector 320. The pointing system may move the solar collector to create an angle with respect to the rays of the sun that would guide the solar radiation toward the thermal block 275. The implementation 300 is described further with reference to FIG. 4.

FIG. 4 is a perspective illustration of a spacecraft 400 in which the implementation 300 of the system 200b may operate. A housing 401 (e.g., housing 330) of the spacecraft 400 has one side removed to show internal components. The system 200b may operate within the spacecraft 400 in conjunction with the solar collector 320, as illustrated in FIG. 3. In FIG. 4, a propellant tank 405 included in the propellant system 290b is fluidicly connected via conduits 408a,b to thrusters 488a-b (which may be two of the thrusters 288a-d). Thrusters 488c-d connect to the tank 405 in a similar manner, although the corresponding conduits are obscured by the housing 401 in FIG. 4. The spacecraft 400 may include a main thruster 489. The main thruster may share propellant with the maneuvering thrusters 488a-d. The main thruster 489 may be a MET thruster and use electrical energy. The electrical energy may be collected using solar cells with or without the use of the solar collector 320 or generated using a thermoelectric plant that may include using the heat accumulated in the thermal block 275.

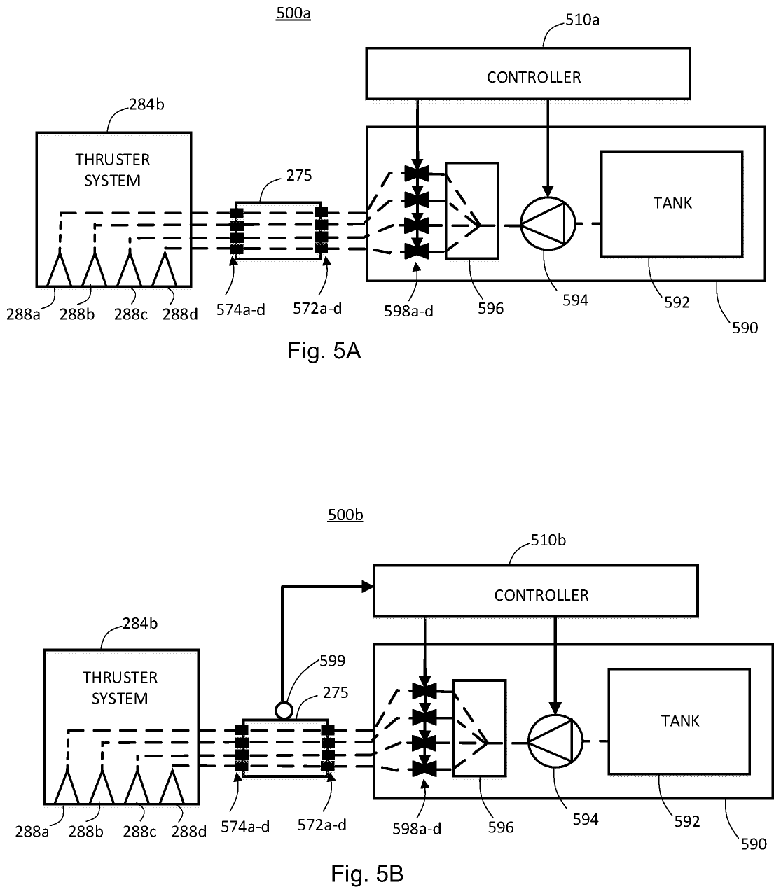

The conduits 408a,b may include pipes or tubes made out of metal or another suitable material and connected in series with suitable connectors. In some implementations, the conduits 408a,b may run through the thermal block 275, the walls of the conduits 408a,b in thermal contact with the thermal block 275. In other implementations, the material of the block 275 may form walls of channels integrated into the block 275. These integrated channels may connect to incoming and outgoing conduits 408a,b to form continuous fluidic channels connecting the tank 405 with the thrusters 488a,b. The integrated channels may help ensure rapid heat transfer from the heat stored in block 275 to the working fluid. One or more pumps, one or more valves, and/or one or more splitters/combiners may be configured to control the flow through the conduits 408a,b and the corresponding fluidic channels. Such pumps, valves and/or splitters are not shown in FIG. 4 to avoid clutter, but discussed below with reference to FIGS. 5 and 6.

The solar concentrator 320 in FIGS. 3 and 4 is illustrated as a curved mirror configured to focus onto the thermal block 275 solar rays approaching the mirror, substantially in parallel, from the direction of the sun. Generally, the solar concentrator 320 may include one or more mirrors, lenses, and/or fiber-optic guides to collect and guide solar radiation toward the block 275 serving as a thermal target. The block 275 is configured to absorb the radiant solar energy, converting it to heat. In some implementations, optics of the solar collector 320 may divert a portion of solar energy to another thermal target or a solar cell array, for example.

As discussed above, a mechanism (e.g., included in the pointing system 340 of FIG. 3) may move the solar collector 320 so as to guide solar radiation toward the block 275. In some implementations, maneuvers to orient the spacecraft 400 as a whole may contribute to positioning of the solar collector 320.

FIGS. 5A, B illustrate example implementations 500a,b of the attitude adjustment thruster system 200b with particular emphasis on enabling thruster system functionality by controlling the propellant system 290b. The implementations 500a,b include controllers 510a,b, implementing at least portions of the propulsion control 140. The controllers 510a,b control a propellant system 590 (example implementations of the propellant system 200b).

The propellant system 590 may include a tank 592 in fluidic connection with a pump 594, a splitter 596, and valves 598a-d. The tank 592 and the pump 594 may be configured to convert a multiphase microgravity mixture of a propellant to a liquid propellant downstream of the pump 596. The splitter 596 may be configured to split the liquid stream from the pump 596 into four portions, each directed to one of the valves 598a-d. In some implementations, the splitter 596 may split the incoming propellant into equal portions under the condition that the valves 598a-d are fully open. In other implementations, the splitter may have asymmetry in the splitting of the incoming stream, even when the valves 598a-d are fully open.

The valves 598a-d may be configured to determine, at least in part, flow rates of the propellant toward each of the thrusters 288a-d. For example, a partial restriction in valve 598a (or 598b-d) may be configured to reduce the flow rate to thruster 288a (or, respectively, thrusters 288b-d). A full closing of one of the valves 598a-d may be configured to fully stop the flow of the propellant to the corresponding thruster.

In operation, the controller 510a (or the controller 510b) may activate the pump 596 when a flight computer (e.g., flight computer 150) signals that attitude adjustment thrust is required to maneuver the spacecraft (e.g., spacecraft 400). The controller 510a (or the controller 510b) may compute the degree to which each of the valves 598a-d is open based on the amount and direction of required thrust. The propellant flows through the valves 598a-d and, via ingress ports 572a-d, into the thermal capacitor block 275 heated to a high temperature. Passing through the block 275, the propellant may vaporize. For example, when water serves as the propellant, the block 275 may convert the propellant into superheated steam. Fluidic conduits (e.g., conduits 408a-b) may then direct to heated gas propellant ejected out of the egress ports 574a-d into each of the thrusters 288a-d. The pressure of the gas in each thruster may depend on the flow rate out of the pump 594 and the degree to which each of the corresponding valves 598a-d is opened. The pressurized propellant gas generates thrust as it exits the thrusters 288a-d. To maximize thrust, the thrusters 288a-d may include suitable expansion nozzles. The thrusters 288a-d disposed at different locations with respect to the center of the spacecraft (e.g., as thrusters 488a-d in FIG. 4) and producing different amounts of thrust, generate torque to turn or maneuver the spacecraft.

The example implementation 500b includes a sensor 599, configured to measure the temperature of the block 275. The sensor may be a thermocouple, a fiberoptic sensor, an IR sensor or any other suitable contact or contactless sensor. The controller 510b may control the pump 594 and/or the valves 598a-d in view of the temperature of the block 275. For example, the controller may increase the power to the pump 594 (and, thereby, the flow rate of the propellant given constant valve configuration) as the temperature of the block 275 decreases. The temperature of the block 275 may decrease, for example, due to radiation losses or due to the heat removed by the propellant flowing through the block 275.

In some implementations, an imaging thermal sensor or a configuration of sensors may measure temperature non-uniformity in the block 275. The controller 510b may control the valves 288a-d in view of the measured temperature non-uniformity. Additionally or alternatively, the controllers 510a,b may use any other suitable inputs, including, for example, motion of the spacecraft (e.g., as measured by accelerometers, gyroscopic, and/or imaging sensors) to control the pump 594 and the valves 598a-d.

FIGS. 6A, B illustrate example thermal capacitor blocks 600a and 600b. The blocks 600a,b may be made of metal (e.g., copper, brass, aluminum, steel, beryllium, or any other suitable metal or allow). In some implementations, the block may be made of ceramic, or any other suitable crystalline or amorphous material. Furthermore, the block material need not be uniform. Portions of the blocks 600a,b may be made of different materials. Generally, tradeoffs between high thermal conductivity, high specific heat, high melting point, low density, low cost, good manufacturability, etc. may dictate the choice of block material.

Although the blocks 600a,b are illustrated in FIGS. 6A,B as parallelepipeds, the blocks 600a,b may have any suitable shape (e.g., cubes, cylinders, cones, truncated cones, toroids, etc.). The blocks 600a,b may be of any suitable dimensions, with linear dimensions of 5, 10, 20, 30, 40, 50 cm or any other suitable value.

In some implementations, a block may include an inner portion and an outer portion of different materials. For example, block 600b may include a cylindrical core 608. The core 608 may include a phase-changing (e.g., two-phase) material that may melt, at least partially, at an operating temperature of the block 600b to store heat in a phase change (as latent heat). Heat storage in a phase change may allow storing heat while maintaining substantially constant temperature that may be an operating temperature of the thermal block 600b. The phase-changing material may be a salt (e.g., chlorides, nitrides, or nitrates of sodium and/or potassium) or a metal (e.g., allows of tin, indium, lithium, lead, etc.) with lower melting point that the outer portion of the block 600b. In some implementations, the phase-changing material may be a material configured to change between a liquid and a gas phase. In some implementations, the thermal block may include a three-phase material, configured to store heat in successive phase changes.

The blocks 600a,b may include respective absorptive surfaces 605a,b configured to absorb a substantial portion (e.g., 50, 60, 70, 80, 90, 95% or more) of the impinging solar radiation (e.g., focused by a solar collector). To that end, in some implementations, the absorptive surfaces 605a,b may be covered with a black paint or another suitable coating. In other implementations, the blocks 605a,b may include plates of absorptive (for a suitable portion of solar spectrum) thermally conductive material (e.g., anodized aluminum).

In some implementations, a thermal block (e.g., blocks 600a,b) may include an electrical heater configured to heat the block. The electrical heater may be configured to carry electrical current to heat the block through Joule heating. The electrical heater may be imbedded in a ceramic (or another dielectric) portion of the thermal block, the ceramic portion conductive thermal coupling to the portion of the thermal block with integrated fluidic channels.

The block 600a includes integrated fluidic channels 612a-d that traverse the block 600a. The block 600b includes integrated fluidic channels 614a,b that traverse the block 600b. Generally, a thermal capacitor block (e.g., blocks 600a,b) may include any suitable number of channels (1, 2, 5, 10, etc.). The channels (e.g., 612a-d and 614a,b) may occupy only a small volumetric portion of the block (e.g., 50, 20, 10, 5, 2, 1% or smaller). The channels may have any suitable shape. The channels may meander through the block and have length substantially greater than any linear dimension of the block. Furthermore, cross-section area of the channels may change along the length of the channels. The increasing cross-section downstream with respect to the flow direction of the propellant may accommodate an increasing volume flow rate as the propellant absorbs heat.

The fluidic channels 612a-d may meander through the thermal block 600a, each channel (612a-d) substantially constrained to a respective one of the four parallel planes. The number of turns may be any suitable number. Fluidic channels 614a-b, on the other hand, have helical portions spiraling through the thermal block 600b. The helical portions of the channels 614a-b may maintain constant distance from the block core 608. Generally, a thermal block may include any suitable number (e.g., 3, 4, 5, 6, 8, 10, etc.) of helical channels. Furthermore, the angular distance between any two channels may stay constant along the length of the block in the direction of propellant flow. In this manner, the helical channels may have substantially equivalent (i.e., symmetrical) relationship to the geometry of the thermal block.

A variety of manufacturing methods may be used to build thermal capacitor block (e.g., blocks 275, 600a,b). In some implementations, a subtractive manufacturing method step may include machining at least a portion of an integrated channel in at least a portion of the thermal block. Another manufacturing step may include assembling portions of the thermal capacitor block with at least partial integrated channels. For example, manufacturing the thermal capacitor block 600a may include steps for machining portions of the block 600a, the portions separated by the planes of the meandering channels 612a-d.

In other implementations, a manufacturing method for a thermal capacitor block (e.g., blocks 275, 600a,b) may include an additive manufacturing step. For example, a three-dimensional (3D) printing step may produce a monolithic thermal block with integrated helical channels. In other implementations, a 3D printing step may produce a solid material portion of a thermal capacitor block (e.g., 600b), while leaving a void for a two-phase portion.

Additionally or alternatively, manufacturing a thermal capacitor block portion with integrated channels may include a combination of additive and subtractive steps. For example, a layer of material of the thermal block may be created (e.g., deposited, fused, etc.) using an additive method. Subsequently, a subtractive manufacturing stem (e.g., mechanical or laser drilling) may create portions of the channels within the layer. The portions of the channels in the layer may traverse the layer at any suitable angle. Thus, for example, the manufacturing method, may create, layer by layer, a thermal capacitor block with integrated helical channels (e.g., block 600b). An additive step of a manufacturing method may deposit subsequent layers in a liquid state, and the subtractive step may create holes in each layer once the corresponding layer solidifies. Thus, integrated channels of a suitable shape may be created.

A device for heating propellant may use a number of techniques for minimizing heat loss of a thermal capacitor block (e.g., block 275) included in the device. The device may include one or more structures for mitigating conductive, convective, and/or radiant heat losses of the thermal capacitor block.

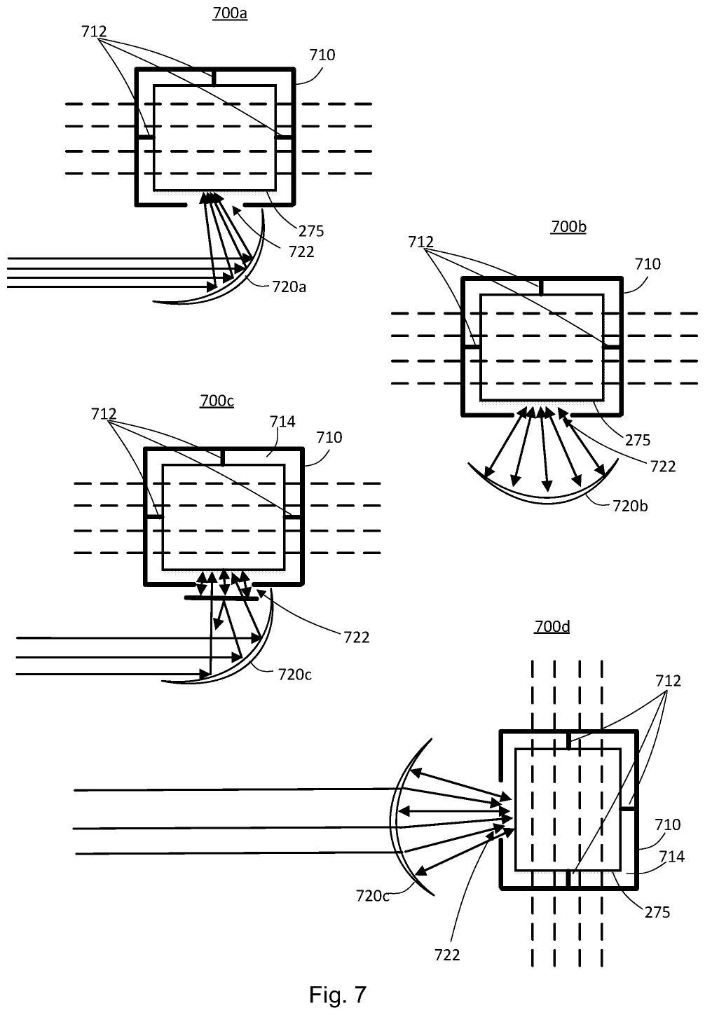

FIG. 7 illustrates configurations 700a-d of a for managing radiant energy transfer between the thermal block 275 and the environment surrounding the thermal block 275 in a device for heating propellant. In configurations 700a-d the device includes a reflector 710 configured to reflect radiant energy emitted by the block 275 back to the block 275. The reflector 710 may surround the thermal block 275 to minimize radiation heat loss. Fluidic conduits connected to ingress and egress ports of the thermal block 275 may penetrate the reflector 710.

The reflector 710 may be attached to the block by stand-offs 712. The stand-offs 712 may minimize conduction of heat from the thermal block 275 to the reflector, while maintaining structural integrity of the device. To that end, the cross-section area of the stand-offs may be minimized and the material of the stand-offs may have suitably low thermal conductivity.

Using the stand-offs 712, the reflector 710 may be substantially separated from the thermal capacitor block 275 by a gap 714. The gap 714 may be substantially vacated of matter (i.e., a vacuum or very low-pressure gap). For example, the gas pressure within the gap may be less than 1/100, 1/1000, or 1/10000 or any other suitable fraction of atmospheric pressure. In a manner of speaking, operating a thermal capacitor block with a reflector separated by the gap 714 advantageously uses the vacuum in the space environment to minimize convective heat loss. Thus, the design of the device for heating the propellant using the thermal capacitance block 275, reflects that the device is configured to operate in the low pressure of the space environment.

The block 275 is configured to receive radiant energy of the sun collected and focused by solar concentrators 720a-c (e.g., solar concentrator 320). The collected and focused solar energy may impinge on the thermal block 275 through a window 722. The window 722 opens an optical path for the solar radiation to reach the thermal block 275. Conversely, the thermal block 275 may lose some heat by radiating through the same optical path (in reverse direction) opened through window 722, particularly when the solar concentrators 720a-c are not collecting solar energy (e.g., when spacecraft does not have a line of sight to the sun). One or more techniques may mitigate radiative heat loss through the window 722. In some implementations, an optical element may mitigate the radiative heat loss by reflecting radiation emitted by the block 275 back to the block 275 along substantially the same optical path as used by the solar radiation focused on the block 275.

In configuration 700a, the solar concentrator 720a may refract the solar rays onto the thermal block 275. A surface of the solar concentrator may be coated to reflect a suitable portion of the infrared (IR) spectrum (e.g., in near- and mid-IR). The IR reflective surface may reflect the radiation emitted by the thermal block 275 back onto the thermal block 275. The coated refractive element of the solar concentrator may act as a concave IR mirror from the perspective of the thermal block 275. Though FIG. 7 illustrates the solar concentrator 720a as a single refractive element, generally, a solar concentrator may combine a suitable number of refractive and/or reflective elements. At least one of the refractive elements in the combination may include a reflective IR coating.

It should be noted that a reflective IR coating may reflect a portion of the impinging solar radiation, reducing the rate of energy collection. However, the spectral shape difference between the solar radiation, centered in the visible portion of the spectrum, and the energy radiated by a heated thermal block (e.g., block 275), centered in IR, contributes to the benefit of the coating for preventing thermal loss. The reflective IR coating may be a transparent heat-reflective (THR) coating, and may include silver, gold, copper, and/or TiO₂, for example.

Configuration 700b may include a filtering element 730, configured to reflect most of the energy emitted by the thermal block 275 back to the thermal block 275, while transmitting the substantial portion of solar radiation collected by the solar concentrator 720. The filtering element may include a coating as described above. In some implementations, the filtering element 730 may be included in the optics of the solar concentrator 720. For example, the filtering element may be a diffractive optical element (e.g., a Fresnel lens) that contributes to focusing the solar radiation onto the thermal block 275.

Configurations 700c and 700d illustrate operational states in a technique of using the solar 720 concentrator to prevent radiative heat loss of the thermal block 275 without relying on a coating or another filtering technique. In configuration 700c, representing the first operational state, the solar concentrator 720 points (e.g., as positioned by the pointing system 340) so as to reflect the radiation emitted by the block 275 back to the block 275. In configuration 700d, representing the second operational state, the solar concentrator 720 points (e.g., as positioned by the pointing system 340) so as to reflect and focus solar radiation onto the block 275. A controller may be configured to receive a signal from a sensor sensing availability of solar energy and position the solar concentrator accordingly. In some implementation, the solar concentrator may be configured with a different focal length depending if the solar concentrator 720 is operating in a collecting (i.e., configuration 700d or retro-reflecting (i.e., configuration 700c) mode. To that end, a mechanical system (e.g., the pointing system 340) may change the curvature of at least one optical element of the solar concentrator 720 in response to a change in the operating mode.

In some implementations, a solar concentrator (e.g., solar concentrator 320, 720) may be configured to help manage excess heat within a spacecraft (e.g., heat generated when operating a main thruster). To that end, the solar concentrator may include a radiating side configured to receive thermal energy from the spacecraft and to radiate the received thermal energy into space.

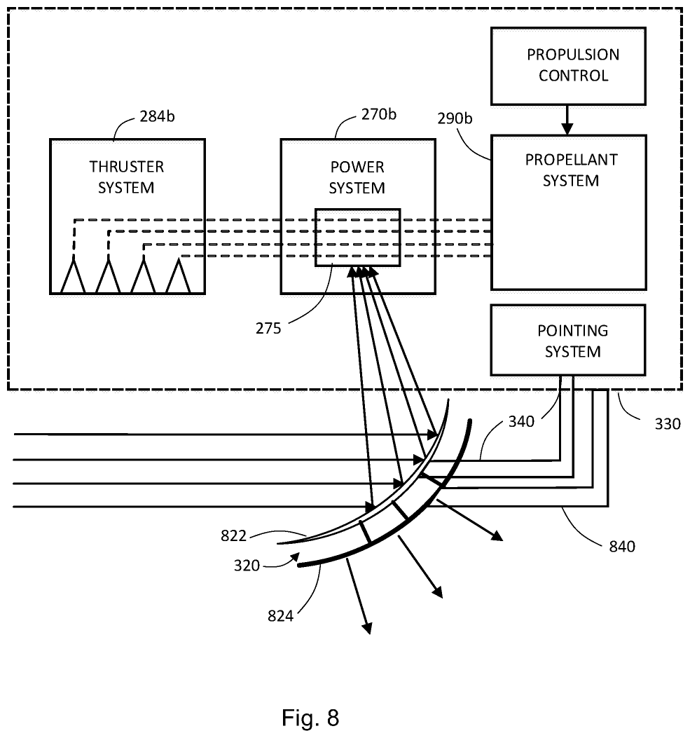

FIG. 8 illustrates an example implementation 800 of the thruster system 200b. The implementation 800 may include a solar concentrator 820 configured to operate in a spacecraft (e.g., spacecraft 400) and collect solar energy. The solar concentrator device 820 may include a reflecting side 822 configured to focus solar radiation on a thermal target disposed at the spacecraft and a radiating side 824 configured to receive thermal energy from the spacecraft and to radiate the received thermal energy. The solar concentrator device 820 may include a heat transfer component 840 configured to transfer heat from the spacecraft to the radiating side 824. The surface of the radiating side 824 may be configured (e.g., painted, coated, anodized, etc.) to have low reflectance, and, consequently, high emissivity. For example, the radiating side 824 may be painted black. Regardless of the apparent color in the visible spectrum, the radiating surface 824 may have a suitably low reflectance (e.g., less than 0.3, 0.2, 0.1 or another suitable value) in the mid-IR spectral region.

A substantial portion of the radiating side 824 may be separated from the reflecting side 822 by a gap, providing thermal insulation between the two sides 822, 824. To that end, the two sides 822, 824 may be separated by stand-offs.

In some implementations, the heat transfer component 840 may conductively transfer the heat from the spacecraft to the radiating side 824. To that end, the heat transfer component may be made of metal (e.g., copper, aluminum, etc.).

In some implementations, the heat transfer component 840 may include a heat pipe to transfer the heat. The heat pipe may be configured to carry hot fluid from a subsystem in the spacecraft to the radiating side 824 of the solar concentrator 820. After transferring heat to the radiating side 824 of the solar concentrator 820, the cooled working fluid may return along the heat pipe to cool the subsystem.

The heat pipe of the heat transfer component 840 may be configured as an active heat pipe equipped with one or more pumps. The pump or pumps may transfer the working fluid between the spacecraft subsystem in need of cooling and the radiating side 824 of the solar concentrator 820. Additionally or alternatively, the heat transfer component 840 may include a passive heat pipe. The passive heat pipe may transfer a condensed working fluid from the radiating side 824 (the cool end of the heat pipe) to the subsystem in need of cooling (the hot end of the heat pipe) using capillary channels of the heat pipe. The working fluid may evaporate at the hot end of the heat pipe, and the evaporated working fluid may expand to the cool end.

The heat transfer component may include rigid fluidic ducts and flexible fluidic ducts. The flexible fluidic ducts may accommodate deployment and movement of the solar concentrator 820.

In some implementations, the working fluid of the heat pipe may be a propellant for one or more thrusters. The propellant may be water, hydrazine, hydrogen peroxide, or any other suitable propellant.

The following aspects are explicitly considered.
Aspect 1. A method of manufacturing a heat exchanger block, the method including: depositing a first layer of block material in liquid form; cooling the first layer of block material until solid; creating holes through the first layer; depositing a second layer of block material in liquid form along a direction of deposition; cooling the second layer of block material until solid; creating holes through the second layer, shifted from the holes in the first layer along the direction transverse to the direction of deposition.
Aspect 2. The method of aspect 1, further comprising using a three-dimensional (3D) printing technique.
Aspect 3. The method of aspect 1, further comprising using a subtractive method to create the holes.

1. A spacecraft maneuvering system comprising:
a propellant tank;
a shared thermal capacitor including a material configured to store thermal energy, the shared thermal capacitor configured to (i) receive, via a plurality of ingress ports, a propellant for a plurality of respective fluidic channels, (ii) transfer the stored thermal energy to the propellant in the plurality of fluidic channels, and (iii) output the propellant from the plurality of fluidic channels via a plurality of a respective egress ports;
a plurality of valves configured to restrict an amount of propellant directed to the respective ingress ports; and
a controller configured to control the plurality of the valves to change flow rates through the plurality of the fluidic channels in response to signals indicative of intended spacecraft maneuvers.

2. The spacecraft maneuvering system of claim 1, further comprising:
a plurality of thrusters fluidicly coupled to respective ones of the plurality of egress ports.

3. The spacecraft maneuvering system of claim 2, wherein the shared thermal capacitor further includes a secondary fluidic channel coupled to a non-thruster component.

4. The spacecraft maneuvering system of claim 3, wherein the secondary fluidic channel is configured to receive a fluid other than the propellant.

5. The spacecraft maneuvering system of claim 3, wherein the secondary fluidic channel is coupled to a turbine for generating electricity.

6. The spacecraft maneuvering system of claim 2, wherein the thermal capacitor is configured to transfer, to the propellant, an amount of thermal energy sufficient to operate the corresponding thruster.

7. The spacecraft maneuvering system of claim 1, wherein the controller is configured to adjust the flow rates in view of a temperature of the shared thermal capacitor.

8. The spacecraft maneuvering system of claim 1, wherein the controller is configured to adjust the flow rates in view of a temperature gradient of the shared thermal capacitor.

9. The spacecraft maneuvering system of claim 1, further comprising:
one or more reflectors to configured to reflect energy in an infrared range radiated by the thermal capacitor block back to the thermal capacitor block.

10. The spacecraft maneuvering system of claim 1, where the plurality of fluidic channels are integrated into the thermal capacitor.

11. The spacecraft maneuvering system of claim 1, wherein each of the one or more fluidic channels has a helical shape.

12. A method of maneuvering a spacecraft, the method comprising:
directing a propellant from a propellant tank to a plurality of fluidic channels in thermal communication with a shared thermal capacitor, via a plurality of respective valves, including controlling, by a controller, flow rates through the valves in accordance with intended spacecraft maneuvers;
transferring thermal energy stored in a material of the thermal capacitor to the propellant in the plurality of fluidic channels; and
directing the propellant from the plurality of fluidic channels to respective ones of a plurality of thrusters.

13. The method of claim 12, further comprising:
transferring, by the thermal capacitor, an amount of thermal energy sufficient to operate the corresponding thruster.

14. The method of claim 12, further comprising adjusting the flow rates in view of a temperature of the shared thermal capacitor.

15. The method of claim 12, further comprising adjusting the flow rates in view of a temperature gradient of the shared thermal capacitor.

16. The method of claim 12, wherein the plurality of fluidic channels are integrated into the thermal capacitor.

17. The method of claim 12, further comprising:
directing a working fluid other than the propellant to a secondary fluidic channel in thermal communication with the thermal capacitor.

18. The method of claim 17, further comprising:
directing the working fluid from the secondary fluidic channel to a turbine for generating electricity.

19. The method of claim 12, further comprising:
using one or more reflectors to reflect energy in an infrared range radiated by the thermal capacitor block back to the thermal capacitor.

20. The method of claim 12, further comprising:
operating in the low-pressure environment with a pressure of less than 0.01 Atm, to reduce heat loss through convection.
